(19) United States
(12) Patent Application Publication
(10) Pub. No.: US 2006/0178998 A1
(43) Pub. Date: Aug. 10, 2006

(54) Personal electronic web health log

(76) Inventor: Peter Kleinschmidt, Munich (DE)

Correspondence Address: Attention: Alexander Burke, Esq.;SIEMENS CORPORATION, Intellectual Property Department, 170 Wood Avenue South, Iselin, NJ, 08830, US

(21) Appl. No.: 10/681,266

(22) Filed: Oct. 9, 2003

(30) Foreign Application Priority Data
Oct. 9, 2002 (DE) 10247151.7

(51) Int. Cl. G06Q 99/00

(52) U.S. Cl. 705/51

(57) ABSTRACT

A personal electronic web health log is for storing, processing and using personal health data associated with a user. It includes a data interface which can be used to set up a communication link to contracting parties when required in order to transfer data from the health log to them at least intermittently. There is preferably a local health log on the user's computer with pre-structured electronic forms for inputting the personal health data, and also a converter, actuated using selection schemes, for producing encrypted data which are anonymous, so that they permit no inference as to the identity of the user, for addressed filing of at least some of the data on a network, such as the internet.

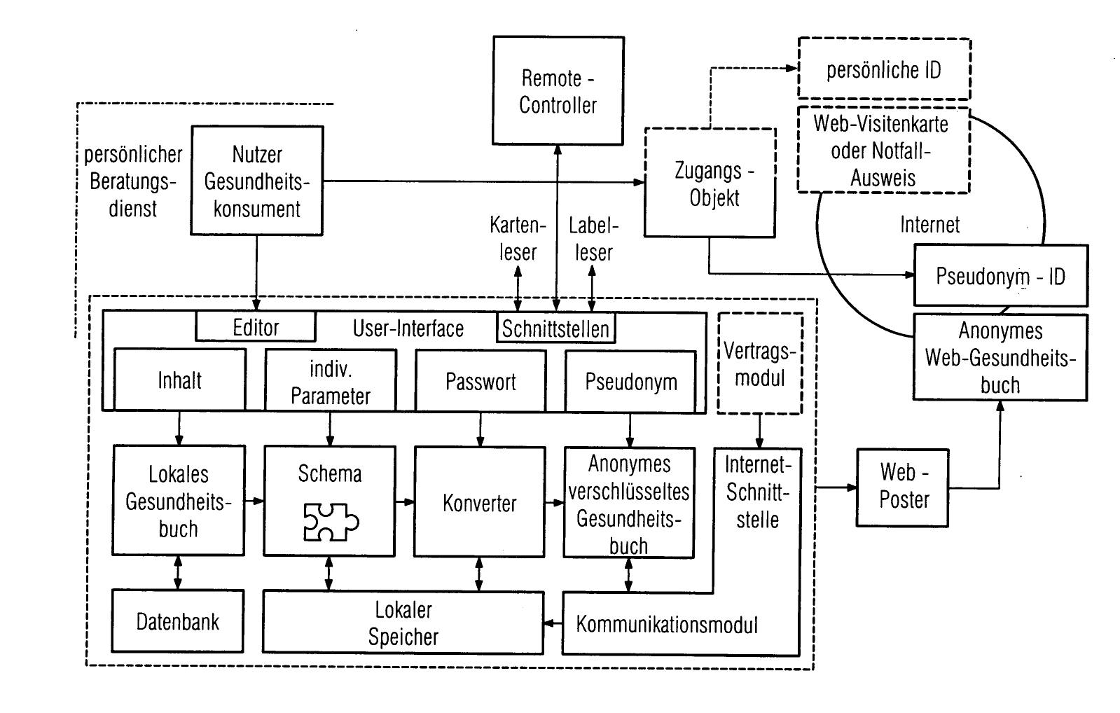

The present application hereby claims priority under 35 U.S.C. §119 on German patent application number DE 102 47 151.7 filed Oct. 9, 2002, the entire contents of which are hereby incorporated herein by reference.

### FIELD OF THE INVENTION

The invention generally relates to a personal electronic web health log for storing processing and using personal health data associated with a user. It preferably includes, having a data interface which can be used to set up a communication link to contracting parties when required in order to transfer data from the health log to them at least intermittently.

### BACKGROUND OF THE INVENTION

Patients and health-conscious consumers currently do not have a safe and guaranteed means way of discrete electronic access to their sensitive health data from all locations. The data are at a wide variety of locations on a wide variety of data levels. They can never entirely make their data personally available to third parties on the health market at any location at will for the purpose of acquiring knowledge, advice and health-promoting services. This would be enormous progress on a consumer-oriented health market, however. (For e-commerce, there is a related, extended solution which is the subject of a parallel invention's application).

Before the Internet existed, the problem did not arise, since electronic presence and communication were not actually possible. In state-regulated health systems, the problem of communicating patient data has been discussed for more than five years on committees set up specifically for the purpose (e.g. the ATG and the ZTG in the Federal Republic of Germany), and there is no prospect of a networking solution. Methods which are customary at present, which are based on the current security structures from signature law, are confronted by the requirement for sensitive health data to be communicated over the Internet securely and with the highest level of personality protection. The method of officially guaranteed identity and the user's desire for personality protection are in conflict in principle.

The rights to the data and the options for action by the parties involved in the health system are also complicatedly regulated by a great variety of laws, which also differ nationally. This means thathus, it is currently not even possible to regulate the data traffic between the institutions involved in the health service on a standard basis. There is even less prospect, it seems, of involving the patient, which would be highly desirable from a medical point of view.

At the present time, a card (health pass) storing the most important data locally now appears to be in the process of becoming accepted. The currently known techniques use a private key infrastructure (PKI) which allows secure transmission of information between authenticated parties. Identification of the parties involved and the existence of central directories give rise to two drawbacks; first, the patient is refused anonymous and soft transaction and consultancy developments. Secondly, the patient rightly feels that he is a glass person to state-controlled institutions. DE 101 26 138.1-53 “Sabotage-proof and censorship-resistant personal electronic health file” proposes a way of allowing patient files to be stored securely and untraceably on the Internet in data capsules. This technique as a partial solution is also useful for implementing the present invention, but is not sufficient to solve the problem posed.

### SUMMARY OF THE INVENTION

The An embodiment of the invention is therefore based on the an object of designing a personal electronic web health log of the type mentioned initially such that it allows diverse processing and use of the personal health data on the consumer-oriented health market, while maintaining the highest possible standard of security for the data.

An embodiment of tThe invention achieves this an object by virtue of such a personal electronic web health log of the type mentioned initially being characterized by a local health log on the user's computer with prestructured electronic forms for inputting the personal health data, and. Further, also a converter my be included, actuated using selection schemes, for producing encrypted data which are anonymous, so that they permit no inference as to the identity of the user, for addressed filing of at least some of the data on the Internet or the like.

The encrypted documents are based on standard formats which can be processed by any Internet browser and which have an internal security mechanism in such a form that a mechanism contained in the document asks the user for a password which can be used to decrypt the document. An example of such an encryptable standard document format is the PDF format from Adobe. It is equally possible to use encryption programs which produce self extracting files and for which the browsers contain a reader plug-in as standard, or can download one from the Internet when required, which initiates the password request. Such documents are suitable for problem-free hosting on the Internet, sending by e-mail and transport on data storage media.

In this case, an embodiment of the invention uses apparatuses or services (web posters) which allow the user to post or to prompt posting of one or more anonymous documents on the web. Such uploading apparatuses (web posters) are known as FTP file transfer programs, e.g. WS_FTP from Ipswitch. For this, the user needs to have or to acquire access to one or more web domains. The anonymous encrypted documents each have an explicit web address (pseudonym ID). Neither these documents nor the anonymous documents which can be reached through them contain an identifying reference to the person behind them themselves.

The relationship between the ID and the person is set up only by the person himself by virtue of the person using the ID. If he wants to make information which can be reached using the latter available to third parties, he should not unnecessarily reveal the pseudonym ID in so doing. All in all, neither does any central data storage take place nor does there exist a central directory connecting person characterizing data and pseudonym data to one another. In principle, the method does not even require any person-characterizing data to be stored at all, but in practice this is advantageous.

In one refinement of an embodiment of the invention, provision can be made for a secure device for filing and finding the pseudonym ID under which the data are filed in encrypted form on the Internet to be provided, so that the user is actually able to refined this pseudonym ID at all times, as far as possible even when he is not sitting in front of his local computer.

To this end, provision can be made, by way of example, for a web visiting card or an emergency ID which contains this pseudonym ID to be stored on the Internet, with these being able to be found only using an authentication device, that is to say a card, a password or the like, for example.

In general, such a personal access object can be apparatuses (e.g. unnoticed typing of codes which have been remembered or have been written down in secret, computer-readable storage media, such as diskettes, magnetic strip cards, devices containing passive chip cards and computers, such as smart cards, mobile devices . . . ) which the user can use to input his pseudonym ID and special passwords for encrypting the data in such a way as to be unseen by third parties, so that he can access his data on the internet himself or can provide third parties with access to his data in his presence using access objects. In the latter case, it is safer to download the encrypted document without displaying it on the screen and to use only the local copy so that the pseudo ID remains secret. For this operation, a new local password can also be allocated. The access object works most securely when it uses a dedicated computer for said operations. The access object can also contain the encrypted file itself.

A fundamental part of such a personal electronic web health log in accordance with an embodiment of the invention is a user interface, protected by an authentication device, for inputting and maintaining data, said the interface being able to comprise include a keyboard and/or interfaces to card and label readers and/or to a remote controller, which is described in a parallel patent application. The authentication devices can comprise include all conventional systems, such as passwords, code cards, sensors for detecting biometric features or the like.

The local health log comprises includes tables with chronological updating, free text fields and link elements, these link elements, which allow jumps to other places in the local health log, other documents and Internet addresses, being able to comprise include, in particular:

link elements for charts and images (e.g. X-ray, ultrasound etc.),

link elements for fax and photo reproductions and also e-malls containing documents and connections to doctors, laboratories or the like having further data.

Such ready-made tables with chronological updating according to date are provided, by way of example, for

occurrences, such as consultations with a doctor, particular own or other people's observations,

standard measurements (weight, blood pressure, ECG, laboratory values, . . . , series of measurements with date)

genetic-test data, screening data, cancer test,

anamnesis, examinations and their results in coded form and/or in plain text and also in the form of images and graphs,

inoculations,

prescriptions,

unlabeled, empty tables for further values.

Free text fields are provided for

other facts for which the tables contain no fields,

short profile with a description of previous history, inherited disposition, risks, intolerances.

The link elements allow jumps to other places in the document, to other documents and Internet addresses.

Link elements are provided for

charts and images (e.g. X-ray, ultrasound, . . . )

fax and photo reproductions of documents,

connections to the doctors and laboratories having further data.

In addition, there is a printable and e-mailable form to be filled in by hand or by computer by the doctor or patient, containing questions relating to the date of the occurrence, the reason, activities, result and systems. The unencrypted originator document (local health log) is continually maintained and therefore needs to be kept securely on an interchangeable storage medium, an encrypted partition of the hard disk or in encrypted form on the Internet.

An important optional section of the health log is provided for tracking and documenting results of personal health programs. Such health programs, which comprise permanent guidance dance and monitoring of the patient/health consumer, are currently still the exception, but in future will play a large part. In this regard, an embodiment of the invention provides:

links to the health programs and services used in order to find them quickly at all times; the option is also provided of briefly documenting the scores, successes and failures on a continual basis and of using the results further.

Optimally, links can be associated with health-related topics and goods and services, advantageously directly with the findings and measurements, images and charts, by filing the links belonging to the topics, goods and services, e.g. in the form of bookmarks for them, on the fields provided for this purpose in and next to the tables and free text fields in the local health log.

The selection schemes can comprise elements of a consistency check for the purpose of checking the data for obvious errors and inconsistencies. In particular, however, the selection schemes comprise filters which are valid for particular questions and which mark those data in the local health log which are important in this regard for targeted partial forwarding.

In the simplest case, such schemes can effect subdivision such that they assign the data to respective appropriate medical areas, with the result that it is possible to make a data selection which comprises all the facts which are of interest to an internist or else the data for the optician or for an orthopedist. It goes without saying that it is naturally also possible for other selection criteria to be provided in this context. The schemes can be defined heuristically or can be derived from recognized guidelines. They can be defined independently or obtained in completed form.

In another refinement of an embodiment of the invention, at least one anonymous encrypted health log which is downstream of the converter and can be connected to the network via the Internet interface can be provided, in which names and communication data for doctors are suppressed as standard and discriminating illnesses or treatments (e.g. psychiatry, Aids, . . . ) are suppressed at the responsibility of the user. The anonymous health log(s) are then hosted as an anonymous web health log on the Internet or the like.

### BRIEF DESCRIPTION OF THE DRAWINGS

Other advantages, features and details of the invention can be found in the description below of an exemplary embodiment and with reference to the drawing, wherein

The drawing which shows a block diagram of a personal electronic web health log in accordance with an embodiment of the invention.

### DETAILED DESCRIPTION OF THE PREFERRED EMBODIMENTS

The user uses the personal electronic web health log shown in the figure for the following methods in particular:

Personal data, maintenance, method of using personal health software to set up a personal local electronic health log by filling in the available fields with already existing data and to maintain it further using data which continue to arise. The method also allows the data in the local health log to be filtered out as desired using schemes and allows the reduced data to be converted into an anonymous health log. The anonymous health log contains no references allowing inference of the user in plain text. (The anonymous health log is encrypted and can be processed and decrypted using any browser provided that the user's personal password is known). The anonymous health log can be kept and transported using any methods, in particular can be hosted on the Internet by any hosts without risk. The user prompts his data to be hosted. The data can be read only with the password which is linked to the user.

Following consultation with or treatment by a doctor or when new knowledge or results comes/come to light, resultant results, facts, assessments, prescriptions and documents and images which are of importance for the future, and also links to the address of the doctor, are transferred to the health log. To this end, the computer has a card reader or an interface or at least a data import facility for reading a future health card associated with the user. Optionally, electronic labels used in future can also be read. This allows data for consumable goods and medicaments to be collected and maintained.

In one preferred embodiment, a “remote controller” can be used in conjunction with the inventive web health log. Besides the card reader and the label reader, this remote controller also comprises additional further input apparatuses and communication devices for easily collecting health related data both from medical appliances and medical products.

Personal data viewing worldwide: the user is able to view the data in the web health log anywhere in the world where there is Internet access. He merely needs his personal access object in order to do so. In the simplest case, this comprises includes records or recollection of the web address and the password.

Making health data available to others: method for providing a doctor or another natural person giving health advice with access to all of the information from the personal health log or to dedicated parts thereof by physically handing over an access object as stipulated, for a respective single time or over a prescribable period of time.

Strengthening contracts by means use of electronic signature; the anonymity of the web health log has the advantage that central censorship is prevented and that even cracking the encryption results in nonassociable data, and informative consultancy can be provided under a very high level of personality protection. By contrast, there is a desire for security for payment transactions and questions relating to the liability of the supplier or of the organization behind said supplier. In such cases, the known mechanisms for private electronic signature can be applied on an adapted security level. In extreme cases, the signature will be necessary according to signature law. In all other cases, the user enjoys increased anonymity.

Automatic logging of measurement and monitoring results and activities: monitoring, tablet taking directly into the log using the remote controller already mentioned above.

Services for assisting the user in performing his computer related activities: it goes without saying that a finished product has a user interface which contains the active parts from said components and summarizes and presents them such that the user understands the functions and processes and has little difficulty in doing what he wants. In all cases in which reference has been made to the patient, health consumer or user, the patient or user can also make use of neutral help services (health consultant, house doctor or others) assisting him in implementation. To this end, he can send, by way of example, the forms in the local personal health log to his health consultant, who products the anonymous Internet presence therefrom.

It is also advantageous for the user of a health service to host personal data on the network. It is thus possible to keep and provide all frequently required nonsensitive data and public keys and photos, always in updated form, using a web visiting card (or home page) merely by providing a personal web ID. This may also be an official citizen's ID with certified signature capability. There are also cases in which personal data together with medical data should be released under light restrictions. These are emergency data, for example. While the “personal web ID” for the visiting card can be freely passed on and a password is nor necessary, the ID in the case of the emergency access object should always be worn visibly on the body (e.g. amulet, vehicle key ring, watch, personal ID, . . . ) and the password should not be visible and should be exposed only in an emergency. Another important use for the personal visiting card is the option of sending messages and passwords in encrypted form and of allowing signature (certifiable in stages) on a case by case basis (but the latter with step by step dropping of anonymity).

It is important to provide good separation between personal and anonymous web spaces in order to prevent coincidences and attacks which could result in associations in this context. The data are collated personally only with and by the user, so that it is not possible to relate the personal data and the anonymous data without the user or his records or his means way of access.

An embodiment of tThe invention represents a change of paradigm for the currently customary medical practice: it uses an identity for which one has one's own responsibility in parallel with the identity managed centrally and officially. The patient himself takes on the responsibility for his health and hence also, in his own interest, for the correctness of the identity details and the correctness of the content of the data supplied to him. It has thus been possible to dispense entirely with the central server architecture regarded as necessary hitherto.

The benefit of an embodiment of the invention is that the patient/user is given power of disposal over his health data using the means of the invention. This power of disposal firstly allows him to inform his partners in health care in a better way, i.e. more extensively and specifically, and secondly allows him to take part in novel electronic transaction processes which can offer him significant added value for his health. The latter aspect is the subject of a parallel patent application.

Specifically for such an electronic transaction process, the contractual module indicated optionally in the figure as well is provided and contains a series of standard contracts and contractual provisions which are of significance in this context.

The statements made have assumed that the user makes his entries in his health log personally. He can also delegate these tasks to a person whom he trusts. In comparable fashion to a tax consultant, this person undertakes the technical procedures for his client with a higher level of expertise. This practice, which is part of an embodiment of the invention, does not change anything about the means of the invention.

Exemplary embodiments being described, it will be obvious that the game may be varied in many ways. Such variations are not to be regarded as a departure from the spirit, and scope of the present invention, and all such modifications as would be obvious in one skilled in the art are intended to be included within the scope of the following claims.

What is claimed is:

1. A personal electronic web health log for personal health data associated with a user, comprising:
a data interface, usable to set up a communication link to contracting parties when required in order to transfer data from the health log to contracting parties at least intermittently, wherein a local health log is included on a user's computer with pre-structured electronic forms for inputting the personal health data; and
a converter, actuated using selection schemes, including filters, valid for particular questions and for marking data in the local health log which are important for targeted partial forwarding, for the purpose of producing anonymous encrypted data permitting no inference as to the identity of the user, for addressed filing of at least some of the data on a network.

2. The web health log as claimed in claim 1, wherein a user interface, protected by an authentication device, is for inputting and maintaining data.

3. The web health log as claimed in claim 2, wherein the user interface includes at least one of a keyboard and at least one interfaces to at least one of a card and label readers and a remote controller.

4. The web health log as claimed in claim 1, wherein the local health log includes tables with chronological updating, free text fields and link elements.

5. The web health log as claimed in claim 4, wherein the link elements, which allow jumps to other places in the local health log, other documents and Internet addresses, include at least one of,
link elements for charts and images,
link elements for fax and photo reproductions- and e-mails containing documents and connections to doctors, laboratories having further data.

6. The web health log as claimed in claim 1, wherein the selection schemes include elements of a consistency check for the purpose of checking the data for obvious errors and inconsistencies.

7. The web health log as claimed in claim 1, wherein at least one anonymous encrypted health log is downstream of the converter, and is positioned at a storage location on the Internet via an Internet interface, and in which names and communication data for doctors are suppressed as standard and discriminating at least one of illnesses and treatments are suppressed at the responsibility of the user.

8. The web health log as claimed in claim 1, further comprising a secure device for filing and finding the pseudonym ID under which the data are filed in encrypted form on the Internet.

9. The web health log as claimed in claim 8, further comprising at least one of a web visiting card and emergency ID, stored on the Internet via an authentication device, which contain the pseudonym ID.

10. The web health log as claimed in claim 1, further comprising a contractual module for transactions on a consumer-oriented health market.

11. The web health log as claimed in claim 2, wherein the local health log includes tables with chronological updating, free text fields and link elements.

12. The web health log as claimed in claim 3, wherein the local health log includes tables with chronological updating, free text fields and link elements.

13. A personal electronic web health log for personal health data associated with a user, comprising:
a data interface, usable to set up a communication link to contracting parties and adapted to transfer data from the heal log to the contracting parties at least intermittently;
a user computer including,
at least a logical health log with prestructured electronic forms for inputting the personal health data, and
a converter, adapted to be actuated using selection schemes, including filters, valid for particular questions and for making data in the local health log which are important for targeted partial forwarding, for the purpose of producing anonymous encrypted data permitting no inference as to the identity of the user, for addressed filing of at least some of the data on a network.

14. The web health log as claimed in clam 2, further comprising a secure device for filing and finding the pseudonym ID under which the data are filed in encrypted form on the Internet.

15. The web health log as claimed in claim 14, further comprising at least one of a web visiting card and emergency ID, stored on the Internet via an authentication device, which contain the pseudonym ID.

16. The web health log as claimed in claim 3, further comprising a secure device for filing and finding the pseudonym ID under which the data are filed in encrypted form on the Internet.

17. The web health log as claimed in claim 16, further comprising at least one of a web visiting card and emergency ID, stored on the Internet via an authentication device, which contain the pseudonym ID.

18. The web health log as claimed in claim 1, wherein the network is the internet.
